(19) United States
(12) Patent Application Publication
(10) Pub. No.: US 2005/0178300 A1
(43) Pub. Date: Aug. 18, 2005

(54) Table base

(75) Inventor: Jay Garfunkle, Lakewood, NJ (US)

Correspondence Address: MCDONNELL BOEHNEN HULBERT & BERGHOFF LLP, 300 S. WACKER DRIVE, 32ND FLOOR, CHICAGO, IL, 60606, US

(73) Assignee: GAR Products, Inc.

(21) Appl. No.: 10/780,253

(22) Filed: Feb. 17, 2004

(51) Int. Cl. G06F 7/00; G06F 17/30; A47B 13/02

(52) U.S. Cl. 108/150

(57) ABSTRACT

The invention is a table base having a base, column and spider plate. Each end of the column is threaded on its external surface, and the spider plate and the base each have a threaded aperture adapted to receive the threaded ends of the column.

### FIELD OF INVENTION

The claimed invention relates generally to an improved pedestal type supporting structure for tables. More particularly, the invention pertains to the interconnection of a column, a base, and a spider plate to provide support to the underside of a table top.

### BACKGROUND OF THE INVENTION

In commercial and industrial settings, pedestal-type table bases are generally favored over other configurations. Accordingly, numerous pedestal type support structures have been developed over the years for holding table tops. Some known prior art includes a Table Top Support (U.S. Pat. No. 4,643,105), a Flip Top Table (U.S. Pat. No. 5,121,697), and a Table Spider Column Connection (U.S. Pat. No. 6,447,199 B1). As shown in these patents, the most prevalent method of securing pedestal type table bases to table tops is to insert a tie rod through a hollow column. The tie rod is then secured to a base and a spider plate using a flanged nut or other well known fastening device.

The primary benefit to using a tie rod to connect a base, column and spider plate is that the separate pieces can be packaged and shipped in smaller containers than an assembled table base, and shipping costs are dramatically reduced. The efficiency gained in shipping, however, is offset by the necessity for on site assembly of the table bases. Assembling the pieces using the tie rod is a labor intensive endeavor, as the tie rod and the column must remain in a concentric relationship in order to maximize the strength of the support structure and the attractiveness of the table while the nut is fastened to the tie rod.

### SUMMARY OF THE INVENTION

The present invention overcomes the problems associated with the prior art by providing an improved table base. In accordance with the present invention, the improved table base comprises a base, a column, and a spider plate. Each end of the column is threaded, and both the base and the spider plate have threaded apertures that are adapted to receive the threaded ends of the column. Accordingly, the base, column and spider plate can be easily assembled by simply screwing the pieces together.

The primary advantage of the present invention is that assembly is simplified, as tools are no longer required to connect the separate pieces of the table base. In addition, by eliminating the need for tie rods and related hardware, the columns, bases, and spider plates can be packaged in smaller containers, further reducing shipping costs for the claimed invention.

It is another feature of the claimed invention to enhance the structural support for a table top. In one embodiment of the claimed invention, the table base is cast from steel and iron in order to provide significant structural integrity and a sturdy support for the table top. In another embodiment, the structural integrity of the claimed table base is enhanced by applying a bonding agent to the threaded ends of the column. Meanwhile, in an alternate embodiment, the structural integrity of the table base is enhanced by locking the rotation of the column with set screws in the base and spider plate.

It is another feature of the claimed invention to provide a versatile system that allows different sizes and shapes of bases, columns, and spider plates to be used interchangeably and removed and replaced as required.

The foregoing and other objects, features and advantages of the present invention will be more readily appreciated by those skilled in the art upon review of and reference to the following detailed description of the drawings and preferred embodiments.

### BRIEF DESCRIPTION OF THE DRAWINGS

FIG. 1 is an exploded plan view of a table base of the present invention.

FIG. 2 is a top perspective view of a first embodiment of a base.

FIG. 3 is a bottom perspective view of a first embodiment of a base.

FIG. 4 is a top perspective view of a second embodiment of a base.

FIG. 5 is a bottom perspective view of a second embodiment of a base.

FIG. 6 is a plan view of a first embodiment of a spider plate.

FIG. 7 is a plan view of an assembled table base.

### DETAILED DESCRIPTION OF PREFERRED EMBODIMENTS

Referring now to the drawings, FIG. 1 shows a typical table base employing the present invention. The table base 1 includes a base 10, a spider plate 40, and a column 80. The column 80 is preferably a steel tube that has threads 86, 90 on the external surface 82 of its first end 84 and its second end 88. The base 10, meanwhile, has a central treaded aperture 12 that is adapted to receive the first threaded end 84 of the column 80. Similarly, the spider plate 40 has a central threaded aperture 42 that is adapted to receive the second threaded end 88 of the column 80.

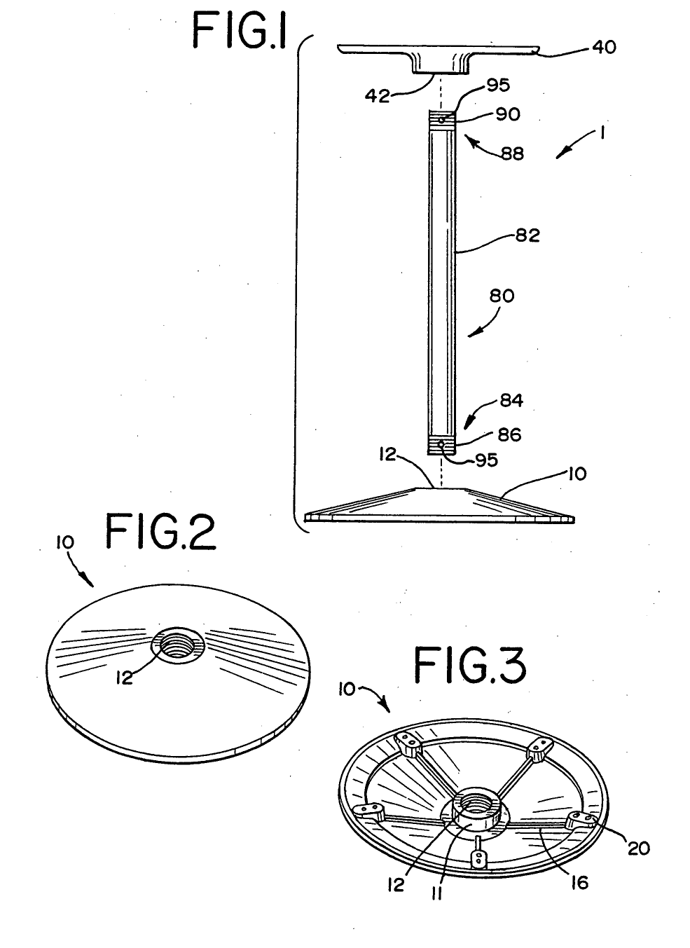

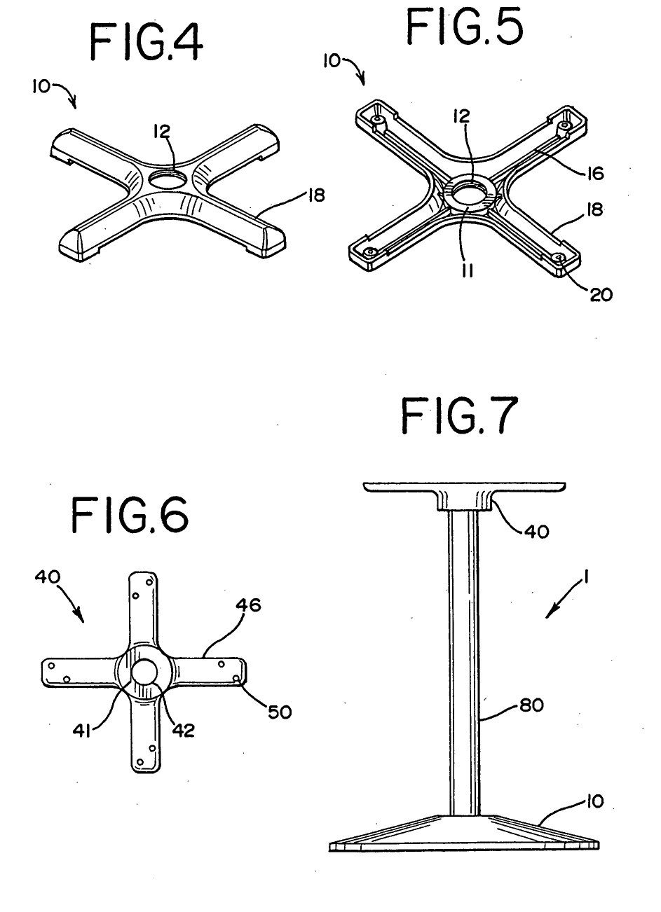

The base 10 could be made in a plurality of shapes and sizes. FIGS. 2 and 3 show the perspective views of the top and bottom, respectively, of one embodiment of a base 10 having a round configuration. Another embodiment of the base 10, one having a plurality of legs 18, is shown in FIGS. 4 and 5. As noted above, each embodiment features an aperture 12 in the center of the base 10. The aperture, in turn, has threads 14 along its interior surface. Each base 10 is also equipped with a plurality of veins 16 for increased strength and durability. In the preferred embodiment, each vein 16 extends radially from a central hub 11 and terminates at a pad 20. The pad 20 supports the base 10 on a floor and can help to protect the floor from being damaged when the base10 is moved across a floor.

Like the base 10, the spider plate 40 can be made in many shapes and sizes. In FIG. 6, a spider plate 40 is shown having a plurality of arms 46. However, one skilled in the art should understand that round spider plates, square spider plates and many other shaped spider plates are well known in the prior art and could be used in accordance with the claimed invention. Regardless of the size and shape, however, each spider plate 40 of the claimed invention has a central aperture 42 that has threads 44 along its interior surface. In FIGS. 1 and 6, the preferred aperture 42 is further shown within a central hub 41. Each spider plate 40 also features a plurality of holes 50 that are used to secure the spider plate to a table top.

When assembled as shown in FIG. 7, the table base 1 of the claimed invention provides a versatile system that can be used to support table tops of various sizes and materials and modified based on a variety of installation requirements. A person skilled in the art should recognize that table tops having different sizes and weights will require corresponding changes in the size, shape and materials used for the base 10, column 80 and spider plate 40 in order to provide a stable support. For instance, table tops made from granite or slate will require larger or heavier bases than tables of the same size made from wood. Preferably, the base 10 and the spider plate 40 are both made from molded cast iron and the column 80 is constructed from 16 gauge steel.

In addition to supporting table tops of various sizes and weights, the claimed invention also allows the height of the column to be modified to accommodate the needs of a customer. A restaurant, for example, may require 36″ or 42″ tables in its bar area as well as standard tables between 28″ and 34″ for its dining room. Using the claimed invention, such a restaurant could simply use different lengths of columns 80 with the same spider plates 40 and bases 10.

The assembly of the claimed invention is quite simple, adding to the versatility of the claimed invention. The external threads 86,90 on the ends 84, 88 of the column 80 and the internal threads 14,44 in the apertures 12, 42 of the base 10 and spider plate 40 allow the table base of the claimed invention to be assembled by hand without the need for any tools. If a permanent assembly is desired, the threads 86, 90 on the ends 84, 88 of the column 80 can be treated with a commercially available bonding agent such as the LOC-TITE brand adhesive. Such bonding agents are activated by the friction generated when the column 80 is screwed into the base 10 and the spider plate 40. In the alternative, if a temporary connection between the column 80, base 10 and spider plate 40 is more desirable, the column 80 can be secured using set screw holes 95 and set screws (not shown). As shown in FIG. 1, the column 80 can be equipped with set screw holes 95 that are bored through each threaded end 84, 88 of the preferred steel tube column 80. The bored set screw holes 95 are also preferably threaded or similarly adapted to receive a set screw (not shown). During assembly of the claimed table base 1, the set screw may be inserted through the set screw hole 95 from the inside of the column 80 until it engages and secures the central hubs 11, 41 of the base 10 and the spider plate 40, respectively. With other embodiments of columns, one skilled in the art should recognize that set screw holes could also be placed in the hubs 11, 4 1, allowing the set screws to engage the column 80 just as many other securing means could be utilized.

The foregoing detailed description is intended to be illustrative rather than limiting. It is the following claims, including all equivalents, which are intended to define the scope of this invention.

1. A table base, comprising:
a base having an aperture with internal threads;
a spider plate having an aperture with internal threads; and
a column having an external surface, a first end having threads on the external surface for engaging the internal threads of the base, and a second end having threads on the external surface for engaging the internal threads of the spider plate.

2. A table base as set forth in claim 1, wherein the base has a central hub surrounding the aperture.

3. A table base as set forth in claim 2, wherein the base has a plurality of support veins extending from the central hub.

4. A table base as set forth in claim 3, wherein each of the plurality of support veins terminates in a floor pad.

5. A table base as set forth in claim 2, wherein the central hub is adapted to receive a set screw.

6. A table base as set forth in claim 1, wherein the spider plate has a central hub surrounding the aperture.

7. A table base as set forth in claim 6, wherein the spider plate has a plurality of support arms extending from the central hub.

8. A table base as set forth in claim 7, wherein each of the plurality of support arms has a plurality of screw holes for attaching the spider plate to a table top.

9. A table base as set forth in claim 6, wherein the central hub is adapted to receive a set screw.

10. A table base as set forth in claim 1, wherein the base and spider plate are manufactured from cast iron.

11. A table base as set forth in claim 1, wherein an adhesive is applied to the threads.

12. A table base as set forth in claim 1, wherein the column is a tube.

13. A table base as set forth in claim 12, wherein the column is manufactured from steel.

14. A table base as set forth in claim 12, wherein the column has a plurality of set screw holes.
